(19) United States
(12) Patent Application Publication
(10) Pub. No.: US 2005/0034441 A1
(43) Pub. Date: Feb. 17, 2005

(54) Olive harvesting machine

(75) Inventors: Carlos Oscar Porta, Venado Tuerto (AR); Hector Oscar Rostan, Venado Tuerto (AR); Pablo Martin Bonadeo, Venado Tuerto (AR)

Correspondence Address: John S. Egbert;Harrison & Egbert, 7th Floor, 412 Main Street, Houston, TX, 77002, US

(73) Assignee: LOS OLIVARES DE VENADO TUERTO S.A., Venado Tuerto (AR)

(21) Appl. No.: 10/640,874

(22) Filed: Aug. 15, 2003

(51) Int. Cl. A01D 46/00

(52) U.S. Cl. 56/328.1

(57) ABSTRACT

Olive harvesting machine of the type that includes a chassis with four wheels, a power engine, and command and transmission devices: the said chassis carries an operator's cab and a frame supporting the rollers placed in opposition to one another, each of which consists of a motorized vertical axle to which are connected several hairs capable of being in physical contact with the branches of the plant. Each of the said hairs is connected to abovementioned vertical axle so that, apart form enabling a turning movement, they allow the free end in the axle to oscillate as compared to the end attached to the axle.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention consists of a harvesting machine especially designed to harvest olives, although in practice it could also be used for the harvesting of other bush-like crops.

This concept makes particular reference to an olive-harvesting machine that enables mechanical harvesting of bushes, rendering a much better yield to that of other machines or to hand harvesting.

### BACKGROUND OF THE INVENTION

From time immemorial, especially at the Mediterranean basin, man has brought in harvest from the olive tree taking advantage of the nutritious characteristics of its fruit, the olive. With the passing of time, it has been proved that olive oil is one of the most beneficial to health. In ancient times, man used to harvest the olive by hand, climbing up the tree and reaping off the fruits. As the tree grew and climbed higher, this technique was replaced by the so-called “knocking-down”, which involves the knocking of the branches in order to make the fruits fall off and, once on the ground, the collection of those fruits. There are in the state of the art certain patents involving devices that allow for a more efficient “knocking-down”, such as that described in the U.S. Pat. No. 5,099,637, which describes a device similar to a rake, although its teeth are covered by a padding material that makes it possible to harvest the olives without causing any harm.

These “knocking-down” techniques, even though still used at present, are reasonably applicable to small harvesting surfaces. In fact, it is very common in certain European countries, such as Italy, to find small producers that have only a few hectares of land where they harvest olives and, due to the reduced number of plants, it is possible to use this harvesting technique.

Therefore, large-scale harvesting of olives calls for the use of some mechanical assisting medium tending to ease production. However, as those large harvesting surfaces are uncommon, due to the olive's low yield as compared to other crops (which usually leads to its replacement), other harvesting machines initially designed for other crops are adapted to harvest olives. The most usual example is that of coffee harvesting machines, or fruit harvesting machines, on which certain adaptations are made so that they may be used on this plant. Obviously, none of them provides an adequate solution because the olive tree has clearly defined characteristics different from those of coffee or fruit plants.

There are in the state of the art several patents involving fruit or coffee harvesting machines. We will simply provide the following examples of United States patents that have characteristics similar to those present in this invention: U.S. Pat. Nos. 5,904,034; 4,077,193; 4,329,836; 4,860,529; 4,974,404; 5,027,593; 5,161,358; 5,220,775; and 5,421,149. All of them are based on a similar concept: they define a self-propelled machine that has at least one or two vertical axles, carrying “fingers” or rods radially arranged onto the said axle, thus altogether defining a sort of vertical “brush” propelled by an engine in the machine that causes it to turn. Once in movement, this “brush” gets closer to the plant causing the fingers to softly knock the branches, thus leading to the orderly shaking of those branches and, without breaking them, it makes the fruits fall off on the ground. Since these machines are designed for trees that are very different from olive trees, they have certain characteristics that are inappropriate for this kind of plant.

A different group of patents that are worth the mention are U.S. Pat. Nos. 5,661,963; 5,904,034; 5,921,074; 6,003,294; 6,158,203; 6,070,402; 5,666,796; 5,660,033; 5,027,593; 5,010,719; 4,982,558; and 4,750,322.

In many of them we can find harvesting machines that treat fruit trees in a very similar way to that referred to herein, with elastic-rod rollers that allow for an adequate shaking intended to cause the fruit to fall off; however, none of them involves the combination of the devices described here, which not only allows for the treatment of large trees, but also combines this with a mechanism that enables the variation of the width of the machine, thus providing for a versatility that is unique in the market.

This invention involves the development of a technique and an experimental system of mechanical harvesting that is to be particularly applied to the olive tree, using a machine that is capable of respecting fundamental principles in view of which it has been created:
A mounting machine (arch over harvesting line). This is due to the fact that it complies with the premise of being more efficient at the time of collection of the fruits and being a more efficient close-capture system, which avoids losses, as compared to a lateral operation machine, and reduces costs, due to the fact that the need for two rides (one for each side of the tree) is eliminated.
The machine must have a size that will enable work on trees of maximum width 4.5 m and height 4.6 m.
The machine can be transported in special carts, respecting applicable legal provisions, of no more than 3.9 m wide and 4.5 m high.
Harvesting headers must be designed in such a way so as to allow for harvesting and avoid harm to plants and trunks, thus preventing damage to the fruit.
Headers are designed so as to adapt themselves the top of the tree and work inside the top.
The machine is to be adapted to the different forms of agronomic operation in trees, according to the kind of pruning: for example, cup-like, cone-like, free type, or in the various types of densities in plants, whether it be in intensive cultivation (200 to 400 plant per ha.) or superintensive (more than 400 plants per ha.).
The collection system must be arranged in such a way so as to be adaptable to the closure on the trees, thus allowing for the collection of fruits, avoiding losses of more than 3%, the knocking of the fruits, and it must cause, by means of a system of belts and norias, the placing of the fruits in boxes, cases, hoppers, or bulk carts.
At the same time, the closure must have a system that will cause the lower branches to move in a certain direction and will protect conveyor belts.
Although accessory to this invention, the machine proposed may also have a pruning and spraying device.

### BRIEF SUMMARY OF THE INVENTION

The object of this invention is an olive harvesting machine having the following features: it has a chassis with four wheels and an internal combustion engine that not only propels the machine, but also provides power to the several pumps included therein. A bodywork is mounted onto the said chassis; this bodywork includes, on the left side, an elevated cab where the operating devices and two seats for the operators are found; furthermore, in agreement with its central front, part of it has a frame that supports the first pair of opposite rollers and two projecting lower paddles. Each of those rollers has several “hairs” or radial fingers that define parallel surfaces of radial fingers among one another. Each of those fingers is associated to a central axle in the brush in such a way that each of them, when turning, also shakes thus creating a combined rotovibration effect. In the lower part close to the ground, and below the said rollers, the machines include internal trays intended to collect the fruits falling off during the operation in the moment the branches are shaken when knocked by the turning fingers. Moreover, it presents a barred lateral surface that prevents the fruits from escaping the reach of the machine during operation, as will be explained below.

### BRIEF DESCRIPTION OF THE VIEW OF THE DRAWING

FIG. 1 shows a perspective overview of the olive harvesting machine proposed, where it can be clearly seen the harvesting rollers, the cab and the front paddles.

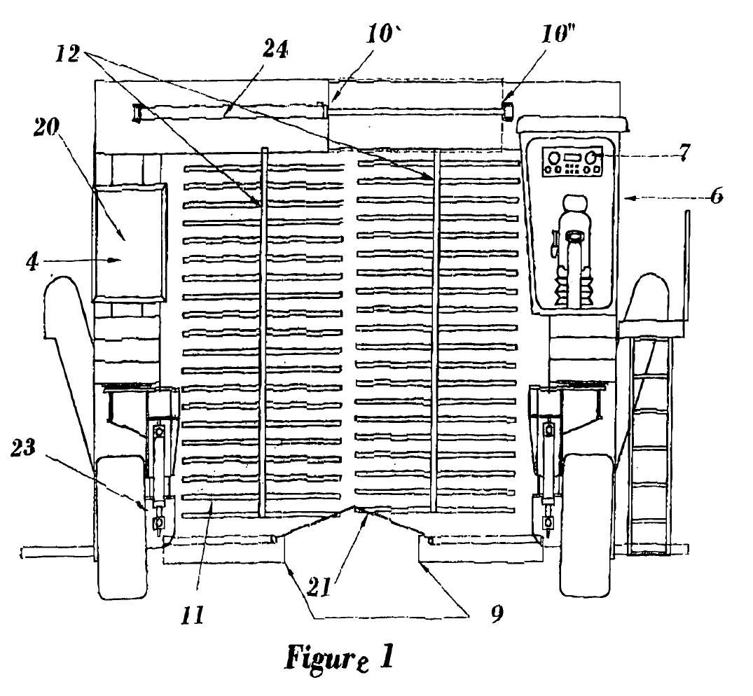

FIG. 2 offers an overhead lateral view, where the arrangement of the rollers and of the operation means is shown.

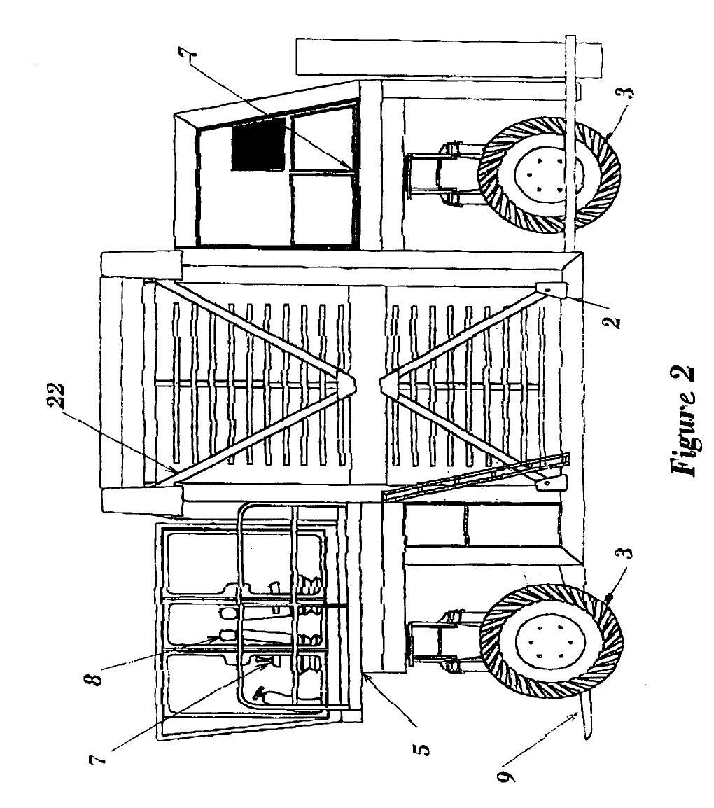

FIG. 3 provides an overhead lateral view showing the barred surface and the rollers.

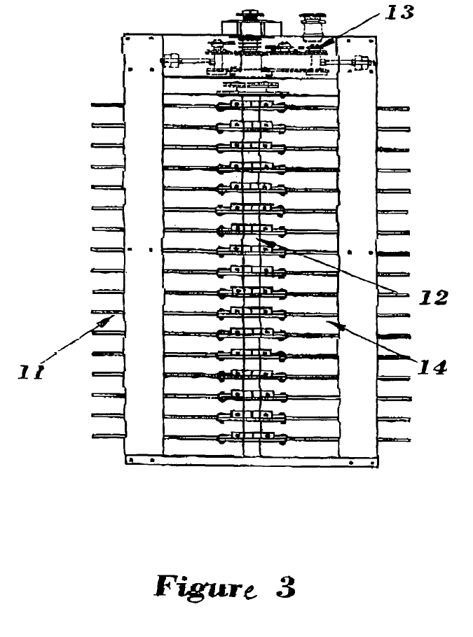

FIG. 4 shows a detail of a roller, as well as the connection of each “hair” to its central axle.

### DETAILED DESCRIPTION OF THE INVENTION

In complete agreement with all that has been illustrated so far, we can see that the machine proposed, indicated by reference 1, comprises chassis 2 with an operating cab having space for two persons, one for the operator and the other for the one in charge of the harvesting system, and with four wheels 3. Wheel supports are telescopic, enabling the elevation or lowering of the machine; the said wheels 3 are turning wheels, being the two at the front the steering ones and the two at the back the correcting ones, having independent operation, thus centering and correcting the movement of the machine, as well as reducing the turning angle at the headland.

An internal combustion engine 4, providing power to the several pumps that start the movable parts in the machine (hydraulic motors and cylinders) by means of a steering box.

On top of the said chassis 2 is mounted bodywork 5 that includes, in an elevated manner and on its right side, cab 6 similar to those included in harvesting machines existing in the state of the art. This cab 6, because it is of traditional design, includes commands 7 in the machine, and seats 8 for the operators.

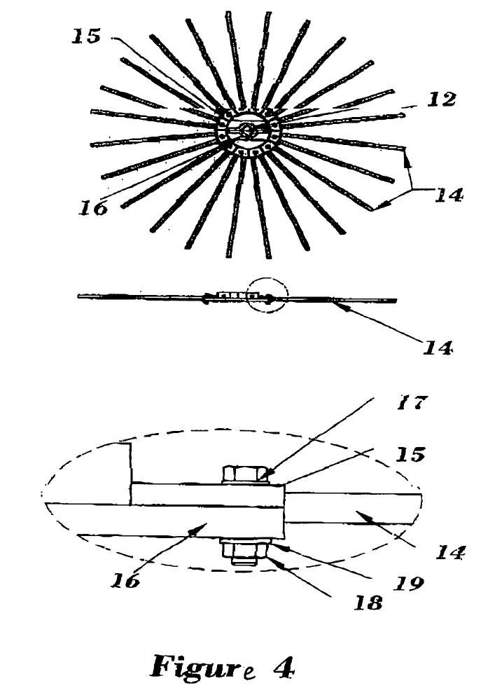

As an integral part to the said chassis 2, in agreement with its central front part, the machine has two paddles 9 that help the machine lead the plant within the harvesting area, as will be explained below. This chassis, in turn, consists of frame 10 supporting rollers 11 arranged in opposition to one another at the front of the machine. Each of these rollers 11 has a vertical central axle 12, connected in their extremes to drives 13, which cause it to turn when harvesting. This axle has several “hairs” or radial fingers 14, each of which is connected to the said axle by means of (see FIG. 4) two hair-pressing plates 15-16 among which these hairs are “pressed” by the joint of the plates caused by bolts 17, with nuts 18 and washers 19. In this way, each “hair” is pressed between plates 15-16, although not touching one another; therefore, each of the said hairs can, because of their extension, oscillate while turning, defining a double action on the branches: not only does the machine knock them when turning, but it also shakes them with its vibration, remarkably improving yield.

This is a feature that is not necessary when harvesting, for example, fruits, and this is the reason why the machine proposed is especially adequate for olive harvesting; it clearly surpasses coffee harvesting machines that are commonly used for this purpose. The axle referred to above turns because of its connection to steering commands propelled by the hydraulic engine.

In the lower part close to the ground, below rollers 1, the machine includes internal trays 21 that enable the collection of the fruits falling off during operation, when the branches are shaken by the knocking of turning fingers.

Furthermore, it presents a lateral wrapping barred surface 22 that prevents the fruits from escaping the reach of the machine during operation due to the fact that, while the machine gets in contact with the plant, many fruits tend to escape from its reach. In order to avoid this from being detrimental to yield, this surface retains inside the machine the fruits falling on the ground on trays 21 described above.

In the lower part, and this is known in the state of the art in other harvesting machines, it includes fruit-collection devices which will not be described in detail as they are not an essential part to this invention.

Finally, it should further be noted that the chassis in the machine includes regulatory means at height 23 that allow for the adaptation of the height of the machine to the average height of the plants to be harvested.

Thus, it can be seen that the machine proposed works in the following way: the operator, once on cab 6, starts engine 20 that propels the machine and provides power to the pumps and commands that, among other functions, cause axles 12 to turn, thus causing rollers 11 to turn as well.

The width of the said frame 10 may be regulated so as to adapt the machine to the characteristics of the plants to be harvested. This is achieved by virtue of hydraulic cylinders 24 that enable lineal movement of positions 10a and 10b of frame 10, moving them apart or getting them closer, as may be necessary, and thus increase or decrease the width of the frame. Obviously, when the width is adjusted, the rollers also move and this depends upon how big and leafy the plants to be harvested may be.

By using the “mouth” defined by the said frame 10, the operator steers the machine so as to place itself in front of the first plant, thus placing it between both rollers 11. When rollers 11 get in contact with the machine, its “hairs” or fingers 12 hit the branches while turning and, in knocking them, the oscillatory movement of each hair causes an additional shaking movement that sensibly improves yield. Improved yield is to be understood as the capacity of the machine to reap off a larger number of fruits from the plant and keep them at a reachable distance, thus avoiding the possibility of losing the ones falling on the ground.

The combined effect of the hairs when turning and oscillating on the branches cause the fruits to fall off due to gravitational force. Below the said rollers, collecting trays 21 prevent the fruits from reaching the ground and, because of their pitch, they carry them to the lower part of the machine where additional collecting devices are found for later treatment.

Structure, Headers, and Collection System

Structure

Two kinds of structures have been developed, basically differing from each other in the width and height of the trees to be treated and in the arrangement of the wheels, which are four in number in both cases. While in one of them there is a symmetrical distribution of wheels, in the other there is a non-symmetrical distribution with a leading wheel, a fixed wheel, and a beam.

The structure is of a telescopic kind, the two lateral sides being joined by telescopic girders at the upper part of the machine; it is sufficiently reinforced both in the upper and lateral sides so as to prevent the paddling of a lateral side as compared to the other; furthermore, the structure is capable of carrying all the weight of the girders in two points.

The machine has a hydraulic movement. It has a hydrostatic transmission with motors in the four wheels, low-turn motors, and important torque. Moreover, the structure has a balancing system by means of hydraulic cylinders that makes it possible for the machine to adapt itself to the different types of surfaces, whether with or without edges.

The system is supplemented by the use of pneumatic lungs that, on the one hand, assure the damping of the machine and, on the other, make it possible for the machine to adapt itself to the irregularity of the land, thus constant transmission is guaranteed and the structure is prevented from adapting itself to variable torsion components.

The operation post has a joystick-like steering grip, which is intended to command the machine to move forward and backwards, move the rear wheels in a certain direction, offer a sensor-operated position of straight movement and alignment; it has a wheel-blocking system intended to be used in case of emergency, a sensor system that allows the machine to position itself as required by the type of trunk; moreover, it commands the opening and closure of structure gauge, and it has a system of automatic or hand-operated raising and lowering of the individual hydraulic operation by means of wheels, as well as a velocity of transfer selector.

The operator's post has two joysticks that command the headers, the purpose of which is to operate the opening and closure of brushes, having a placing device intended to enable operation when using only one of them; the said operation post has a symmetrical or non-symmetrical opening system. Furthermore, it regulates the speed in the rotors and the breaking force, as well as the operation of belts, wheels, and blowers.

Power consists of a diesel motor that starts the steering box that provides the necessary mechanical force for the operation of three hydraulic pumps. One of them corresponds to the hydrostatic transmission system, another one to the general operation of hydraulic motors and cylinders, and the third one controls a double pump that operates the harvesting headers.

Headers

Two kinds of headers have been developed and one of them offers three alternatives:

Rotovibrating Brushes

They consist in a movement system, a breaking control system, and a group of rods that are the ones that work directly on the tree, the movement of which is caused by that of non-centered masses in relation to a central point (inertial non-equilibrium of masses). Differences are based on the anchoring system and weight of the masses, thus achieving important inertia that allows for low-turn functioning with great inertial force.

Rods are arranged in a radial manner and there are two alternatives for such an arrangement: one of them is tangential in the front or back and applies to a knocking system that may require greater penetration or collection speed in superintensive systems.

A mechanical breaking system has been developed for the rotovibrating brushes (hydraulically operated breaking discs) that allow for the control of the knocks of the rods and the brush-rotation system.

The brush headers are located in a structure that slides on rails that enable the brushes to run perpendicular to the movement of the machine. This is an innovative design in two respects. On the one hand, it allows for adaptation to the canopying of the trees and, on the other, it makes it possible to place the brushes within the branches without causing any damage due to the fact that the agronomic shape of the tree is respected. This system, together with the possibility of changing the gauge, allows for this machine to be used on different types of crops.

Rods are made of a polyamide 6 center, covered by rubber so as to avoid harm to the olives; the rods are arranged in a radial manner every 15 degrees at a horizontal level, thus amounting to a total of 24 rods per level, affixed to an aluminum structure in contact with the main axle. The different levels of the rods may be placed apart from one another between 7 cm and 15 cm, according to the density of rods required by the various kinds of crops.

The aluminum plates holding the rods may be affixed to an adapter that allows for a tangential distribution of the rods up to a total of 18 per level.

Vibrating Plates

This system has been developed for its use in a lateral manner in Spanish conduction-type trees, where the mechanical knocking down of the rods is made more difficult in their lower part.

It consists of 6 columns arranged in parallel lines, having a distance from one another of 25 cm, which tilt over an axis, with a distribution of rods in contact with each column at a distance of 7 cm from one another. The operation involves moving odd columns to the right and even columns to the left, and vice versa. This process simulates the crossing of the rods that cause the fruits to fall off.

It has also been designed for its use in replacement of rotovibrating brushes.

Collection System

This system consists of two conveyor belts in the front, which have been horizontally placed along the machine, thus leaving an open space between each other; this space may be adapted according to the movement of the upper telescopic girders so that, when the structure is closed, the belts touch one another and, when they move, the distance between internal tips in the belt will reach from 180 cm to 140 cm in accordance with the two designs referred to above.

This belt places the fruit collected in some other rear belts that are horizontally placed 90 degrees from the abovementioned ones. These belts place the fruit in two norias arranged at 45 degrees, which place the fruit in boxes, bins or carts. The said norias are of a balancing type so that they may be folded on the chassis and, thus, the external dimensions are not altered in the event of cart transportation.

When the structure of the machine is open, a polycarbon plate device is placed, joined to a tube by means of rubber tips, which makes them tilt. This is so because the paddles, due to their distribution and geometry, give place to a very tight closure against the trunk of the trees and, when the machine moves forward, these paddles move away from the trunks, thus allowing for the closure to be maintained on one side and, on the other, the paddles are affixed with a pitch of 23 degrees in relation to the horizontal line so as to make the fruit roll and to place it on the front belts.

Below the structure a device is placed 20 cm from the inside of the belts, which work as a banister and offer protection to the belts; above the paddles, bars are also placed to lead the movement of the lower branches of the tree so that the brushes can work on them.

In front of the belts two oscillating pontoons are placed; the system is supplemented by two front doors and two rear doors that prevent the fruit from being ejected through the front or back sides. The velocities in the belts and norias may be regulated and they are mainly dependent upon the varieties of plants to be harvested.

The machine has a pre-cleaning system that makes it possible to separate the leaves and boughs from the fruit. This system consists in two fans that control the air between the front and rear belts and in the lower movement of the norias; it also comprises a system of two rollers arranged on back belts that separate the fruit from the boughs.

Below the belt protectors a constant sensor has been placed, which is intended to monitor the position of the machine at all times so as to keep it centered in relation to the position of the trunks. It involves two tap-rooted bars at the ends and a sensor for angle-position that transmits the information to the operator's cab so as to enable the correction, automatically or by hand operation, of the position in the correcting wheels.

Pruning System

This system consist in the simultaneous or alternative placing of cutting bars with circular saws of 45 cm in diameter, mounted on the space where the rotovibrating carts run; it is possible to control cutting angles of the bars and to adapt them, when using the positioning cylinders, to the various needs of the crop concerned.

Bars are useful not only for the top but also for the lateral sides of the tree.

From what has been explained so far, it is clear that by means of an ingenious and simple creation it is possible to define an olive-harvesting machine, offering a high level of yield, adequate costs, and simple maintenance.

Every crop arranged in lines with trees or bushes of a width of 4.5 m and a height of 4.6 mt may use the proposed invention as a harvesting system, whether it be by knocking-down, collection, cleaning collection, storage or pruning, and collection and storage. Examples: fruits, citrus fruits, coffee plants, vine, tea, mate.

1. Olive harvesting machine comprising: a chassis with four wheels, a power engine, and command and transmission devices; wherein said chassis carries an operator's cab, as well as a frame holding rollers arranged in opposition to one another, each roller of which has a motorized vertical axle with which several hairs are in contact; said hairs being capable of being in physical contact with branches of a plant; wherein each of these hairs is in connection with a vertical axle in such a way that, apart from turning movement, an oscillation in free extreme is enabled as compared to the extreme attached to the axle.

2. Olive harvesting machine, according to claim 1, wherein a connection between the vertical axle and each of the hairs is comprised of two paddles in contact with the vertical axle by means of bolts with nuts and washer that define an adjustment by pressure of the said hair.

3. Olive harvesting machine, according to claim 1, wherein each axle comprises several series of hairs in a radial or tangential distribution, a center being comprised of polyamide or hytrel of 16 mm in diameter and covered by a rubber of 19-24 mm in internal and external diameter.

4. Olive harvesting machine, according to claim 2, further comprising, between each series of hairs, at the same height, a variable separating bushing capable of allowing for an equidistant position among all the series is placed.

5. An olive harvesting machine, according to claim 1 further comprising a Riding Structure with Variable Gauge so as to adapt internal free width to carry out and perform several different works on trees of a size of up to 4.5 m wide and 4.6 m high and, when the structure is retracted making the lateral levels get closer to one another, it can be transported in carts along national routes while respecting applicable regulations concerning width and height requirements.

6. An olive harvesting machine, according to claim 1, further comprising a Structure to hold different headers for olive harvesting in particular, and for its use in other fruit and citric trees, as well as spraying and pruning devices.

7. An olive harvesting machine, according to claim 1, wherein Arrangement of all the elements, cab, hydraulic pumps set. Fans, oil and gasoline tanks; electrovalves block located at the lateral sides of the machine.

8. An olive harvesting machine according to claim 1, wherein Two steering wheels and correcting wheels system have a wide turning angle with a centering device in the machine.

9. An olive harvesting machine according to claim 1, having a Low-height design with a single connection to the structure, the center turning point being in coincidence with the center of the tire.

10. An olive harvesting machine according to claim 1, further comprising a telescopic elevation system by means of the use of square rails and hydraulic cylinders that, together with the use of gas accumulators, allow for adaptation to the shape of the land eliminating the need for additional effort of the lateral sides of the machine and assuring constant drive in the four wheels.

11. An olive harvesting machine according to claim 1, further comprising an assembly of the collection headers that allow for a movement that is perpendicular and horizontal to the movement of the machine, thus making it possible for it to easily reach the center of the tree.

12. An olive harvesting machine, according to claim 1, further comprising an Affixing system of the rotovibrating system located in a structure that runs along fixing rails that prevent vibration from affecting the structure.

13. An olive harvesting machine, according to claim 1, further comprising a fruit collection system, paddles design, mounting of paddles, tree-position sensor, belts and norias command, and system of separation of leaves by air, as well as box or bin carrying device.
